(19) United States
(12) Patent Application Publication
(10) Pub. No.: US 2022/0123887 A1
(43) Pub. Date: Apr. 21, 2022

(54) CHANNEL SOUNDING USING MULTIPLE ANTENNA PANELS

(71) Applicant: Sony Group Corporation, Tokyo (JP)

(72) Inventors: Olof ZANDER, Södra Sandby (SE); Kun ZHAO, Stockholm (SE); Fredrik RUSEK, Eslöv (SE); Torgny PALENIUS, Barsebäck (SE); Erik BENGTSSON, Eslöv (SE)

(21) Appl. No.: 17/421,893

(22) PCT Filed: Jan. 9, 2020
(86) PCT No.: PCT/EP2020/050445

§ 371 Date: Jul. 9, 2021

(30) Foreign Application Priority Data
Jan. 11, 2019 (SE) 1930011-0

(51) Int. Cl. H04L 5/00; H04B 7/06

(52) U.S. Cl. CPC H04L 5/0048; H04B 7/0602

(57) ABSTRACT

A method of operating a wireless communication device (102) includes generating (1001) a reference signal sequence (150) based on a base signal sequence and a shift signal sequence selected from a plurality of candidate shift signal sequences transmitting (1002) the reference signal sequence (150) via an antenna port (5031-5033) of a plurality of antenna ports (5031-5033) of the wireless communication device (102) and via an antenna panel (5023, 5024) of a plurality of antenna panels (5023, 5024) of the wireless communication device (102). The shift signal sequence is selected from the plurality of candidate shift signal sequences depending on the antenna panel (5023, 5024) used for transmitting the reference signal sequence (150).

### TECHNICAL FIELD

Various examples of the invention generally relate to communicating sounding reference signals. Various examples of the invention specifically relate to communicating sounding reference signals and an indication regarding an antenna panel used for transmitting the sounding reference signals.

### BACKGROUND

In mobile communication, there is a continued need for (i) higher transmission throughput, and (ii) reduction of power consumption of mobile communication devices (sometimes also referred to as user equipment, UE).

Some UEs include an array of antennas (antenna array) that can transmit and/or receive (communicate) in a beamformed manner. I.e., phase-coherent transmission across the antennas of the antenna array of the antenna panel is possible. Thereby, it is possible to communicate on dedicated beams. Thereby, spatial multiplexing and/or spatial diversity may be used to increase the transmission throughput.

Some UEs include multiple antenna panels, each antenna panel including one or more antenna arrays. By provisioning multiple antenna panels the flexibility in communicating on multiple beams is increased. This helps to further increase the transmission throughput.

On the other hand, it has been found that operating multiple antenna panels can sometimes increase the power consumption at the UE.

For example, from the Third Generation Partnership Project (3GPP) document R1-1813334, it is known to use sounding reference signals (SRS) sequences for uplink (UL) beam management. The association between SRS resource and the antenna panel can be reported by the UE and then the network can configure SRS resource indices corresponding to a small number of UE panels when expected gain of using a larger number of UE antenna panels is marginal. Also see 3GPP R1-1813490.

Such reporting may face the drawback of increased control signaling overhead on a wireless link between the UE and the network.

### SUMMARY

Therefore, there is a need of advanced techniques of implementing communication in a communication system including a transmitter and a receiver, the transmitter including multiple antenna panels for beamforming. Specifically, there is a need for techniques which overcome or mitigate at least some of the above-identified restrictions and drawbacks.

This need is met by the features of the independent claims. The features of the dependent claims define embodiments.

A method of operating a wireless communication device comprises generating a reference signal sequence based on a base signal sequence and a shift signal sequence selected from a plurality of candidate shift signal sequences. The method also includes transmitting the reference signal sequence via an antenna port of a plurality of antenna ports of the wireless communication device and via an antenna panel of a plurality of antenna panels of the wireless communication device. The shift signal sequence is selected from the plurality of candidate shift signal sequences depending on the antenna port and/or the antenna panel used for transmitting the reference signal sequence.

A computer program or a computer program or a computer-readable storage medium includes program code. The program code can be executed by a control circuitry. Executing the program code causes the control circuitry to perform a method of operating a wireless communication device. The method includes generating a reference signal sequence based on a base signal sequence and a shift signal sequence selected from a plurality of candidate shift signal sequences. The method also includes transmitting the reference signal sequence via an antenna port of a plurality of antenna ports of the wireless communication device and via an antenna panel of a plurality of antenna panels of the wireless communication device. The shift signal sequence is selected from the plurality of candidate shift signal sequences depending on the antenna port and/or the antenna panel used for transmitting the reference signal sequence.

A method of operating a wireless communication device comprises controlling a modem to generate a reference signal sequence based on a base signal sequence and a shift signal sequence selected from a plurality of candidate shift signal sequences. The method also includes controlling the modem to transmit the reference signal sequence via an antenna port of a plurality of antenna ports of the wireless communication device and via an antenna panel of a plurality of antenna panels of the wireless communication device. The shift signal sequence is selected from the plurality of candidate shift signal sequences depending on the antenna port and the antenna panel used for transmitting the reference signal sequence.

A method of operating an access node of a communications network includes receiving a signal sequence from a wireless communication device and comparing the signal sequence with candidate shift signal sequences of a plurality of candidate shift signal sequences. Each one of the candidate shift signal sequences is associated with an antenna panel of a plurality of antenna panels of the wireless communication device and an antenna port of a plurality of antenna ports of the wireless communication device. The method also includes determining the antenna panel and the antenna port based on said comparing.

A computer program or a computer program or a computer-readable storage medium includes program code. The program code can be executed by a control circuitry. Executing the program code causes the control circuitry to perform a method of operating an access node of a communications network. The method includes receiving a signal sequence from a wireless communication device and comparing the signal sequence with candidate shift signal sequences of a plurality of candidate shift signal sequences. Each one of the candidate shift signal sequences is associated with an antenna panel of a plurality of antenna panels of the wireless communication device and an antenna port of a plurality of antenna ports of the wireless communication device. The method also includes determining the antenna panel and the antenna port based on said comparing.

A method of operating an access node of a communications network includes controlling a modem to receive a signal sequence from a wireless communication device and to compare the signal sequence with candidate shift signal sequences of a plurality of candidate shift signal sequences. Each one of the candidate shift signal sequences is associated with an antenna panel of a plurality of antenna panels of the wireless communication device and an antenna port of a plurality of antenna ports of the wireless communication device. The method also includes determining the antenna panel and the antenna port based on said comparing.

A wireless communication device includes control circuitry configured to generate a reference signal sequence based on a base signal sequence and a shift signal sequence selected from a plurality of candidate shift signal sequences; and to transmit the reference signal sequence via an antenna port of a plurality of antenna ports of the wireless communication device and via an antenna panel of a plurality of antenna panels of the wireless communication device. The shift signal sequence is selected from the plurality of candidate shift signal sequences depending on the antenna port and the antenna panel used for transmitting the reference signal sequence.

An access node of a communications network includes control circuitry configured to receive a signal sequence from a wireless communication device; and to compare the signal sequence with candidate shift signal sequences of a plurality of candidate shift signal sequences, each one of the candidate shift signal sequences being associated with an antenna panel of a plurality of antenna panels of the wireless communication device and an antenna port of a plurality of antenna ports of the wireless communication device. The control circuitry is further configured to determine the antenna panel and the antenna port based on said comparing.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a communication system according to various examples.

FIG. 2 schematically illustrates details of nodes of the communication system according to FIG. 1.

FIG. 3 schematically illustrates details of a wireless interface of a node of the communication system according to FIG. 1.

FIG. 4 schematically illustrates a time-frequency resource grid including multiple resource elements allocated for transmission of SRS sequences according to various examples.

FIG. 5 is a flowchart of method according to various examples.

FIG. 6 is a flowchart of method according to various examples.

FIG. 7 schematically illustrates a mapping between (i) antenna ports and antenna panels and (ii) candidate shift signal sequences according to various examples.

FIG. 8 schematically illustrates a mapping between (i) antenna ports and antenna panels and (ii) candidate shift signal sequences according to various examples.

FIG. 9 is a flowchart of method according to various examples.

FIG. 10 is a signaling diagram according to various examples.

FIG. 11 is a flowchart of method according to various examples.

FIG.12 is a flowchart of method according to various examples.

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

Hereinafter, techniques of wirelessly communicating using a communications system including two or more nodes are described. The nodes can implement a transmitter and a receiver. For example, the communications system can be implemented by a communications network and a UE that can be connected or connectable to the communications network.

The communications network (or, simply, network) may be a wireless network. For sake of simplicity, various scenarios are described hereinafter with respect to an implementation of the communications network by a cellular network. The cellular network includes multiple cells. Each cell corresponds to a respective sub-area of the overall coverage area. Other example implementations include Institute of Electrical and Electronics Engineers (IEEE) WLAN network, MulteFire, etc.

Hereinafter, techniques are described which facilitate transmission of signals by a UE comprising a wireless interface, the wireless interface including a modem, multiple antenna ports, and multiple antenna panels. As a general rule, the modem may include a digital front end and an analog front end.

A signal sequence may be output in the radio frequency (RF) band by the modem, e.g., in the range of 1 GHz to 40 GHz. As a general rule, a signal sequence may include multiple time-sequential symbols, each symbol encoding a number of bits. Specifically, because the modem can include multiple antenna ports, it is possible that the modem outputs multiple signal sequences, one via each antenna port. For example, the modem may include multiple amplifiers and phase shifters, e.g., one per antenna port. Antenna ports may thus be logical entities with distinguished reference signals. Antenna ports may be logical entities defined by the modem, mapped to physical connectors. For example, antenna ports may be defined on a physical layer according the open system interface (OSI) model. Symbols and sequences that are transmitted over an antenna port are subject to the same propagation conditions on the wireless link. Details with respect to antenna ports are described, e.g., in 3GPP Technical Specification (TS) 36.211 V15.0.0 (2017 December), section 5.2.1. As a general rule, each antenna panel may include one or more antenna arrays. Each antenna array may include multiple antennas in a well-defined spatial arrangement with respect to each other. Phase-coherent transmission can be implemented by an antenna array. Here, the phase and amplitude of each RF signal fed to the various antennas of the array may be defined with respect to each other. Thereby, beamforming becomes possible.

Beamforming generally describes a technique of applying directivity onto the transmission of RF signals: by using constructive and destructive interference between RF signals transmitted by different antennas of the antenna array, a preferred direction can be defined along which the RF energy is focused. Thereby, beamforming may facilitate spatial multiplexing and/or spatial diversity to thereby increase the transmission throughput.

The techniques described herein facilitate efficient and accurate beam management. Beam management generally describes logic associated with selecting the appropriate one or more beams for communication between the UE and an access node of the communications network. For UL communication, a transmit beam at the UE may be selected. It would also be possible to select a receive beam at the BS for UL communication. For DL communication, a receive beam at the UE may be selected. It would also be possible to select a transmit beam at the BS.

For beam management of UL communication, the UE may transmit one or more UL reference signal sequences. An example UL reference signal sequence is the UL SRS sequence, see 3GPP TS 36.211 V15.0.0 (2017 December), section 5.5.3; or 3GPP TS 38.211 V15.3.0, section 6.4.1.3.3. While—as a general rule—various kinds and types of UL reference signal sequences may be used, hereinafter, various examples will be described in connection with SRS sequences, for sake of simplicity. As a general rule, there may be a one-to-one mapping between SRS sequences and antenna ports.

The communications network can measure a receive property of the UL SRS sequences, e.g., amplitude, phase, etc. Then, the network can determine a quality of a respective physical transmission channel from the UE to the access node, the physical transmission channel being associated with a corresponding transmit beam at the UE and a transmission path from the UE to an access node (AN) of the communications network (and, generally, a receive beam of the AN). Such process is generally referred to as channel sounding. The beam management is then based on the channel sounding.

Hereinafter, techniques are described which facilitate reduction of power consumption at the UE. The techniques described herein may facilitate efficient and accurate channel sounding. The techniques thereby enable selection of the appropriate beam for reliable and power-efficient transmission. Thus, beam management can be tailored.

According to various examples, this is achieved by providing an information on an association between SRS sequences transmitted by the UE and the respective antenna ports and/or antenna panels used for transmitting.

Thereby, it would be possible to take into account activation or deactivation of antenna panels when performing the beam management. For example, it would be possible to select one or more beams formed by an antenna array of a first antenna panel so that a second antenna panel can be deactivated. Thus, the power consumption at the UE can be reduced.

As a general rule, there are various options available for providing the information on the association between the SRS sequences and the respective antenna ports and/or antenna panels.

For example, such information regarding the association between SRS sequences and antenna panels is provided in a backwards-compatible manner. Thus, it is possible to re-use existing protocols and standards, thus reducing complexity.

As a further example, such information regarding the association between SRS sequences and antenna panels may be provided in an implicit manner. Thus, an explicit indicator or separate control signaling may not be required, thereby reducing control signaling overhead. The reduction of control signaling overhead increases the power efficiency at the UE. Also, the overall data throughput may be increased, because spectrum access is reduced.

For example, it would be possible that the UE employs different UL SRS sequences for different antenna ports. By using outputting UL SRS sequences via different antenna ports, different beams can be selected. Thereby, a comparison can be made between the quality of the physical transmission channels (and transmit beams) associated with the different antenna ports, by considering the receive properties of the different UL SRS sequences. Hence, the SRS sequences may be indicative of the respective antenna port used for transmission.

It would also possible that the UE employs different SRS sequences for different antenna panels. Thereby, a comparison can be made between the quality of physical transmission channels associated with the different antenna panels, by considering the receive properties of the different UL SRS sequences. Hence, the SRS sequences may be indicative of the respective antenna panel used for transmission. For example, it would be possible that an UL SRS sequence is selected from a plurality of candidate UL SRS sequences based on the particular antenna panel via which the UL SRS sequence is then transmitted.

There are generally various options available to implement different SRS sequences for different antenna panels and antenna ports. In one option, it would be possible to select different base sequences associated with the SRS sequences for different antenna ports and antenna panels. In a further option, the UL SRS sequence can be generated based on a base signal sequence and a shift signal sequence, wherein different shift signal sequences are selected for different antenna ports and antenna panels. In other words, it would be possible that the shift signal sequence is selected from a plurality of candidate shift signal sequences depending on the antenna panel. In other words, according to such option, the same base signal sequence may be used for different UL SRS sequences that are transmitted via different antenna panels, but different shift signal sequences may be used for the different UL SRS sequences.

At the AN, by comparing a received signal sequence (e.g., a SRS sequence) with the various candidate shift signal sequences, it becomes possible to identify the particular shift signal sequence used at the UE; then, the AN can conclude back on the antenna panel used for transmitting the SRS sequence at the UE. The AN can then use this information as part of the beam management. For example, the AN can select the appropriate transmit beam for the UE based on the antenna panel used for transmitting the SRS sequence. An example comparison includes a correlation of the received signal sequence with the various candidate shift signal sequences.

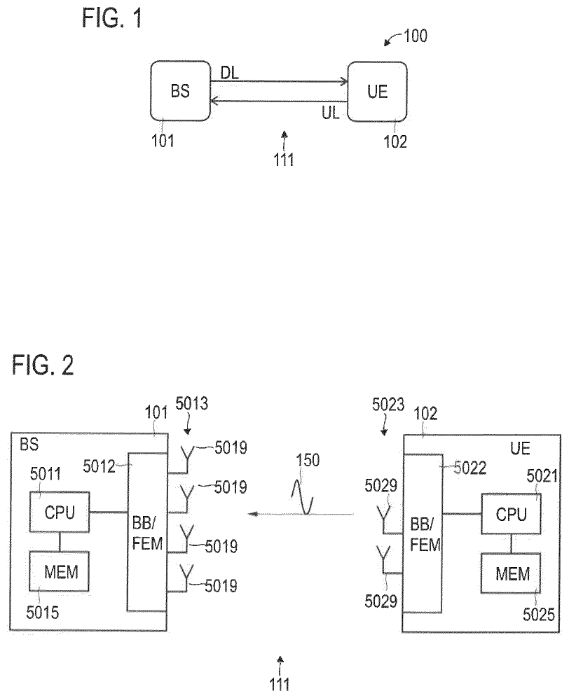

FIG. 1 schematically illustrates a wireless communication system 100 that may benefit from the techniques disclosed herein.

The wireless communication system 100 includes an AN 101 of a cellular network (not shown in FIG. 1) and a UE 102. Because the AN 101 is part of a cellular network, reference is made to a base station (BS) hereinafter. In other types of communication systems, other types of ANs may be employed.

A wireless link 111 is established between the AN 101 and the UE 102. The wireless link 111 includes a downlink (DL) link from the AN 101 to the UE 102; and further includes an UL link from the UE 102 to the AN 101.

The UE 102 may be one of the following: a smartphone; a cellular phone; a table; a notebook; a computer; a smart TV; an MTC device; an eMTC device; an IoT device; an NB-IoT device; a sensor; an actuator; etc.

FIG. 2 schematically illustrates the BS 101 and the UE 102 in greater detail.

The BS 101 includes a processor 5011, a memory 5015, and a wireless interface 5012 (labeled base band/front end module, BB/FEM in FIG. 2), forming control circuitry. The wireless interface 5012 is coupled via antenna ports (not shown in FIG. 2) with an antenna panel 5013 including a plurality of antennas 5019 that form an antenna array.

The memory 5015 may be a non-volatile memory. The memory 5015 may store program code that can be executed by the processor 5011. Executing the program code may cause the processor 5011 to perform techniques with respect to: receiving signal sequences; comparing (e.g., correlating) the received signal sequences with reference signal sequences; participating in beam management; etc.

The UE 102 includes a processor 5021, a memory 5025, and a wireless interface 5022 (labeled base band/front end module, BB/FEM in FIG. 2), forming control circuitry. The wireless interface 5022 is coupled via antenna ports (not shown in FIG. 2) with an antenna panel 5023 including a plurality of antennas 5029.

The memory 5025 may be a non-volatile memory. The memory 5025 may store program code that can be executed by the processor 5021. Executing the program code may cause the processor 5021 to perform techniques with respect to: controlling a modem of the wireless interface 5022 to generate a SRS sequence 150; controlling the modem to transmit a SRS sequence 150; participating in beam management; etc.

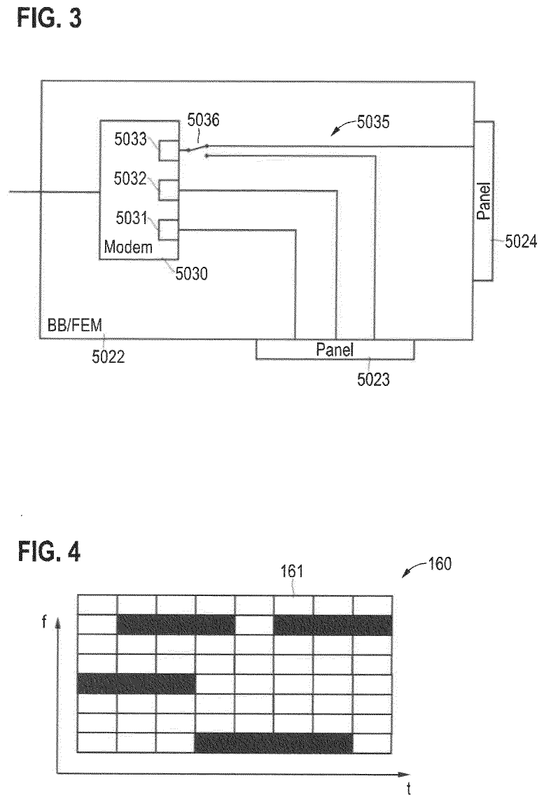

While in FIG. 2 a scenario is illustrated in which the UE 102 includes a single antenna panel 5023; generally, the UE 102 may include more than a single antenna panel. Such a scenario is illustrated in FIG. 3.

FIG. 3 illustrates aspects with respect to the wireless interface 5022 of the UE 102. As illustrated in FIG. 3, the wireless interface 5022 includes a modem 5030 including three antenna ports 5031-5033. These antenna ports 5031-5033 are coupled via a wiring 5035 with two antenna panels 5023-5024.

In the example of FIG. 3, the wiring 5035 defines a coupling between the antenna port 5031 and the panel 5023, between the antenna port 5032 and the antenna panel 5023, and between the antenna port 5033 and the antenna panels 5023-5024. A—generally optional—switch 5036 is provided that can route the RF signal output by the antenna port 5033 either to the antenna panel 5023, or to the antenna panel 5024.

As a general rule, the wiring 5035 can be configured differently for different wireless interfaces 5022 of different UEs 102. This motivates the finding that there can be a benefit from reporting information on the association between SRS sequences and antenna panels. Further details with respect to the transmission of SRS sequences are described in connection with FIG. 4.

FIG. 4 illustrates aspects with respect to time-frequency resource elements 161 used for transmitting SRS sequences on the wireless link 111. As illustrated in FIG. 4, a time-frequency grid 160 defines multiple time-frequency resource elements 161. For example, an Orthogonal Frequency Division Multiplex (OFDM) technique including a carrier and multiple sub-carriers and defining timeslots for symbols can be used to define such time-frequency grid 160.

The time-frequency grid 160 facilitates time division duplexing (TDD) and frequency division duplexing (FDD): signals transmitted in different time-frequency resource elements 161 do not interfere.

Some of the time-frequency resource elements 161 are used for transmitting SRS (in FIG. 4, these time-frequency resource elements 161 are marked with a black filling). For example, the BS 101 and the UE 102 can agree upon the particular time-frequency resource elements 161 used for transmitting SRS.

Specifically, sequences of time-frequency resource elements 161 are used for transmitting SRS sequences. An SRS sequence can occupy multiple sequential time-frequency resource elements 161, e.g., a count of M resource elements.

As a general rule, in addition to TDD and FDD it is possible to employ code division duplexing (CDD). Specifically, CDD can be employed for transmitting SRS sequences. By using CDD, SRS sequences originating from multiple antenna ports 5031-5033 can share time-frequency resource elements 161. This can increase the spectrum utilization. (Note that while FIG. 4 illustrates, for sake of simplicity, a common time-frequency resource grid 160, the operational implementation can sometimes include individual definition of time-frequency resource grids before OFDM inverse Fourier transfer operation). Next, details with respect to CDD will be explained.

A SRS sequence can be implemented by a Zadoff-Chu sequence s=[s₁ s₂ . . . s_{M}] of length M, where M is variable from 12 to 1000 or more. Further, the SRS sequence is associated to a specific antenna port, k, and there is maximum L antenna ports allowed, thus, k ranges from 1 to at most L. The SRS sequence, 150 xₖ transmitted from antenna port k=1 . . . L is formed according to

xₖ=[xₖ₁ xₖ₂ . . . x_{kM}], (1)

where

xₖₘ=sₘfₖₘ, (2)

fₖₘ=exp(iφₖ(m−1)/M), and (3)

φₖ ϵ {0, π/2, π, 3π/2}. (4)

In words, different SRS sequences sent from different antenna ports share the same base sequence s (sometimes also referred to as root sequence), but differ since they are elementwise multiplied with different numbers {fₖₘ}, see Eq. (2). φₖ is sometimes referred to as cyclic shift.

The vector fₖ

fₖ=[fₖ₁ fₖ₂ . . . f_{kM}]. (5)

corresponds to a so-called shift signal sequence. According to signal theory, the vector fₖ defines a discrete Fourier transformation of the base sequence, see Eq. (3). Thus, in time domain, this corresponds to a shift.

The above facilitates transmitting SRS sequences from different antenna ports overlapped in the time-frequency grid 160 using CDD. Thus, at a specific time-frequency resource element 161, indexed by m from {1 . . . M}, the transmitted signal is x₁ₘ+x₂ₘ+x₃ₘ+x₄ₘ₊ . . . X_{Lm}. M is also the length of the base sequence sₘ, cf. Eq. (1).

Although the SRS sequences from different antenna ports are overlapped in the time-frequency grid 160, they can be separated at the BS 101 since the multiplicative constants {fₖₘ} of the shift signal sequences form orthogonal sequences, i.e., fₖfₗ^{H}=0, k≠l. There is a count of M orthogonal vectors fₖ, i.e., a count of M candidate shift signal sequences to choose from.

According to various examples, it is possible to generate the SRS sequence based on a predefined/fixed base signal sequence and shift signal sequence that is selected from the candidate shift signal sequences. Specifically, the shift signal sequence of a given SRS sequence can be selected from the candidate shift signal sequences based on the respective antenna port and the respective antenna panel via which the given SRS sequences to be transmitted.

For this, a new index n is used to denote all candidate shift signal sequences

fₖ→fₙ, (6)

wherein the index nₖₚ depends on, both, k=1 . . . L (i.e., the antenna port) and p=1 . . . P (i.e., the antenna panel). Hence:

n=1 . . . N, (7)

N≤L*P, (8)

considering that not all antenna ports may be connected to all antenna panels, depending on the wiring 5035 (cf. FIG. 3).

For example, let

T=Σₖ₌₁^{L} u(k), (8A)

define the number of total possible couplings between antenna ports and antenna panels. Here, u(k) specifies the number of antenna panels to which antenna port k is coupled. It follows: T≤L*P; and u(k)≤P for all k.

Since there is a count of M orthogonal vectors fₖ, it is desirable to have:

N≤M (9)

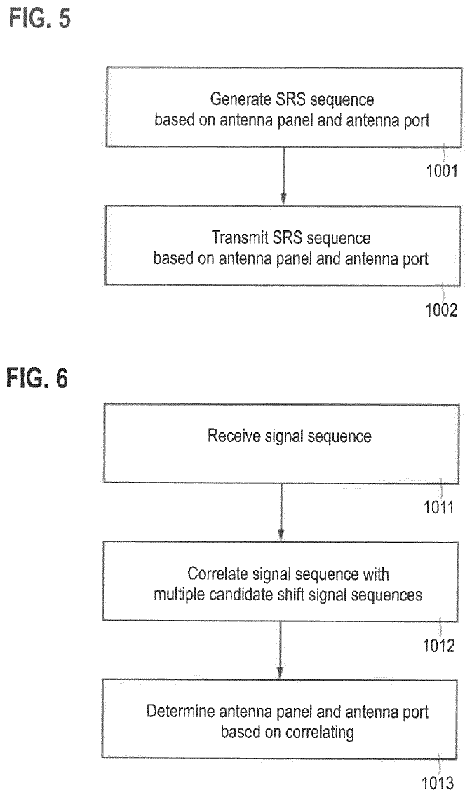

The selection of the appropriate shift signal sequence based on, both, the antenna port and the antenna panel, is also illustrated in connection with FIG. 5 and FIG. 6.

FIG. 5 is a flowchart of a method according to various examples. The method of FIG. 5 can be executed by a UE, e.g., the UE 102 according to FIG. 1 and FIG. 2. More specifically, FIG. 5 could be executed by a modem 5030 of a wireless interface 5022 of the UE 102.

At block 1001, an SRS sequence is generated based on a base signal sequence and a shift signal sequence, the shift signal sequence being selected from a plurality of candidate shift signal sequences.

At block 1002, the generated SRS sequence is transmitted via an antenna port of a plurality of antenna ports of the UE and via antenna panel of a plurality of antenna panels of the UE.

In block 1001, the shift signal sequence is selected from the plurality of candidate shift signal sequences depending on the particular antenna port and the particular antenna panel via which the SRS sequence is transmitted in block 1002.

Thereby, the SRS sequence is implicitly indicative of the antenna port and the antenna panel. Thereby, the receiving BS can conclude back on the antenna port and the antenna panel. The receiving BS may use this information to implement beam management. Corresponding techniques are described in connection with FIG. 6.

FIG. 6 is a flowchart of a method according to various examples. The method of FIG. 6 can be executed by a BS, e.g., the BS 101 according to FIG. 1 and FIG. 2. More specifically, FIG. 6 could be executed by the wireless interface 5012 and/or the processor 5011 of the BS 101.

At block 1011, a signal sequence is received, e.g., from a UE. For example, the signal sequence can be received in one or more resource elements of a time-frequency resource grid allocated for the transmission of an SRS sequence (cf. FIG. 4).

Next, at block 1012, the signal sequence received at block 1011 is correlated with one or more candidate shift signal sequences. A time-domain correlation is employed. Other types of comparison are also possible.

Then, at block 1013, the antenna panel and the antenna port are determined based on the correlation of block 1012. For example, a correlation maximum may be identified. The correlation maximum then corresponds to the shift signal sequence used at the UE; based on the shift signal sequence, the BS can then conclude back on the particular antenna port and antenna panel employed by the UE.

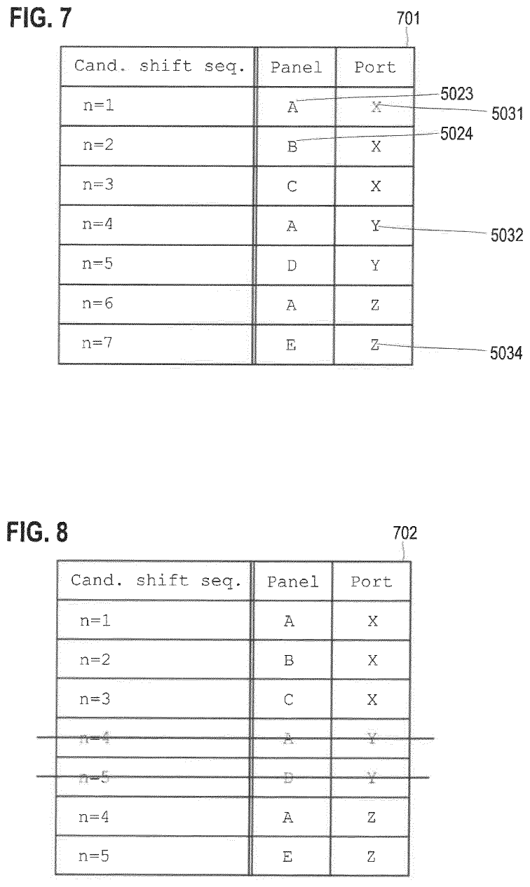

This association between (i) antenna ports and antenna panels, and (ii) candidate shift signal sequences used by the BS to conclude back on the particular antenna port and antenna panel employed by the UE for transmitting a SRS sequence can be implemented by a predefined mapping. It would also be possible that the mapping is synchronized between the UE and the network. The UE may use the mapping to select the appropriate shift signal sequence from the plurality of candidate shift signal sequences, depending on the antenna port and antenna panel. Details with respect to such mapping are illustrated in connection with FIG. 7 and FIG. 8.

FIG. 7 illustrates aspects with respect to a mapping 701 between (i) multiple antenna ports in multiple antenna panels and (ii) corresponding shift signal sequences. Different candidate shift sequences are associated with different antenna panels and antenna ports.

As illustrated in FIG. 7, not all of the antenna ports can transmit via each antenna panel: for example, the antenna port labelled “X” (corresponding to antenna port 5031 of FIG. 3) can transmit via the antenna panels labelled “A” (corresponding to antenna panel 5023 of FIG. 3), “B” (corresponding to antenna panel 5024 of FIG. 3), and “C”, but not via the antenna panels labelled “D” and “E”. Such limitations can be imposed by the wiring 5035 between the modem 5030 and the antenna panels 5023-5024 (cf. FIG. 3). Thus, the mapping 701 corresponds to the wiring 5035.

The mapping 701 may be employed by the UE 102 when generating the SRS sequence based on a shift signal sequence; the shift signal sequence can be selected from the candidate shift signal sequences identified by the mapping 701 based on the particular antenna panel and antenna port to be used (cf FIG. 5: block 1001).

The mapping 701 may also be used by the BS 101 when determining the antenna panel and the antenna port; the BS 101 can implement correlations of a received signal sequence with at least some of the candidate shift signal sequences indicated by the mapping 701 (cf. FIG. 6: block 1013); and then, based on the mapping, determine the antenna panel and antenna port associated with the candidate shift signal sequence associated yielding the correlation maximum.

The UE 102 and the BS 101 should use the same mapping 701. As such, it would be possible that the mapping 701 is predefined, e.g., according to a standard according to which, both, the UE 102, as well as the BS 101 operate. Alternatively or additionally, it would also be possible that the mapping 701 is synchronized between the BS 101 and the UE 102, e.g., using control signaling.

To accommodate for all antenna port—antenna panel pairs according to the example of FIG. 7, it is required to provide for a count of seven candidate shift signal sequences. Where M>7, this is feasible (cf. Eq. 9). Sometimes, the number M of available orthogonal candidate shift signal sequences—cf. Eq. (3)—is limited. For example, there may be a tendency to reduce the number of available orthogonal candidate shift signal sequences by reducing the length of the base sequence, to thereby reduce the signaling overhead required for SRS sequence transmission. Shorter base sequences result in fewer time-frequency resource elements 161 to be reserved for SRS sequence transmission. Thus, a situation can occur where there are insufficient candidate shift signal sequences available to accommodate for all possible pairs of (i) the plurality of antenna ports and the plurality of antenna panels, and (ii) candidate shift signal sequences.

To mitigate such situation, it would be possible to determine the mapping taking into consideration deactivated antenna panels and deactivated antenna ports. Such a scenario is illustrated in FIG. 8.

FIG. 8 illustrates aspects with respect to a mapping 702 between (i) multiple antenna ports and multiple antenna panels, and (ii) corresponding shift signal sequences. The mapping 702 according to the example of FIG. 8 generally corresponds to the mapping 701 according to the example of FIG. 7.

In the example of FIG. 8, the mapping 702 is determined based on the activated antenna ports “X” and “Z”, only. The antenna port “Y” is deactivated and hence removed from the mapping 702. Thereby, the number of required candidate shift signal sequences can be reduced to 5. Thus, the dimensioning of M is relaxed, cf. Eq. (9). Control signaling overhead can be reduced, by allocating shorter sequences of time-frequency resource elements for the transmission of SRS sequences.

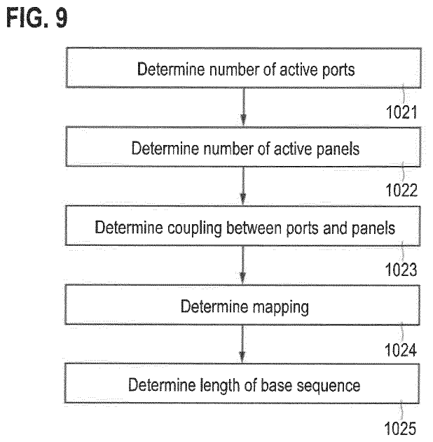

Alternatively or additionally to reducing the number of required candidate shift signal sequences, a further measure would be to increase the length of the base sequence such that a larger number of candidate shift signal sequences is inherently available. Thus, M may be increased. Such techniques are described in connection with FIG. 9.

FIG. 9 is a flowchart of a method according to various examples. FIG. 9 describes aspects in connection with determining the mapping 701, 702 between (i) multiple antenna ports on multiple antenna panels, and (ii) corresponding candidate shift signal sequences. For example, the method of FIG. 9 may be executed fully or partly at the UE. It would also be possible that the method of FIG. 9 is executed fully or partly at the BS.

At block 1021, active antenna ports are determined. In other words, non-deactivated antenna ports are determined. For example, deactivated ports may be in a shut-down state or a sleep state where RF signals may not be output via the deactivated antenna ports.

At block 1022, active antenna panels are determined. In other words, non-deactivated antenna panels are determined. For example, deactivated antenna panels may be in a shut-down state or sleep state where transmission of RF signals is not possible.

At block 1023, couplings of a wiring of the antenna panels and the antenna ports are determined (cf. FIG. 3). Specifically, the couplings of the wiring of the active antenna panels and the active antenna ports are determined, based on the result of blocks 1021 and 1022.

Then, at block 1024, the mapping is determined. This can be based on the couplings of the wiring of the active antenna ports and active antenna panels. Specifically, it would be possible to assign a corresponding candidate shift signal sequence to each active antenna panel—active antenna port pair possible in view of the coupling according to block 1023.

Then, based on the number of required candidate shift signal sequences it is possible to determine the length of the base signal sequence, block 1025. The length of the base signal sequence can be selected so that it is long enough to accommodate for all required candidate shift signal sequences, but as short as possible to limit signaling overhead.

While in the example given above, a discrimination is made between activated and deactivate antenna ports and antenna panels, this is generally optional. Similarly, it is generally optional to consider details of the wiring. In a simple scenario, the length of the base signal sequence may be determined according to L*P≤M (assuming that all antenna panels and all antenna ports are activated and coupled with each other).

Hence, as a general rule, it would be, hence, possible to select the length of the base signal sequence depending on the count of antenna ports and/or the count of antenna panels and/or a coupling between antenna ports and antenna panels. For example, the length of the base sequence may be selected such that M>T, see Eq. (8A). In words: the length of the base sequence may be selected so that for all possible couplings between antenna ports and antenna panels a dedicated shift signal sequence is available and pair-wise orthogonality of the shift signal sequences is persevered.

Optionally, the activation state of the antenna panels and/or the activation state of the antenna ports can be taken into account. For example, in Eq. (8A), the sum may only run over all activated antenna ports.

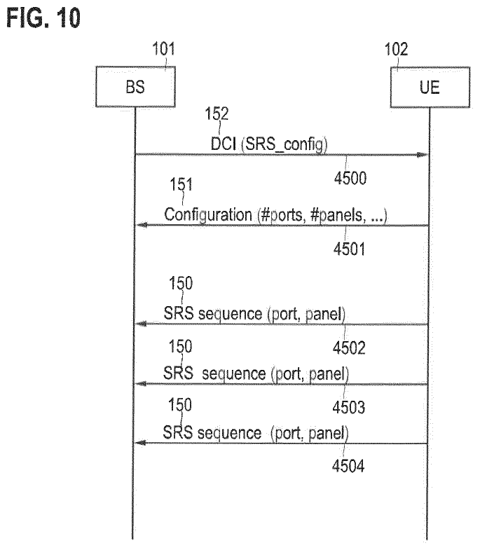

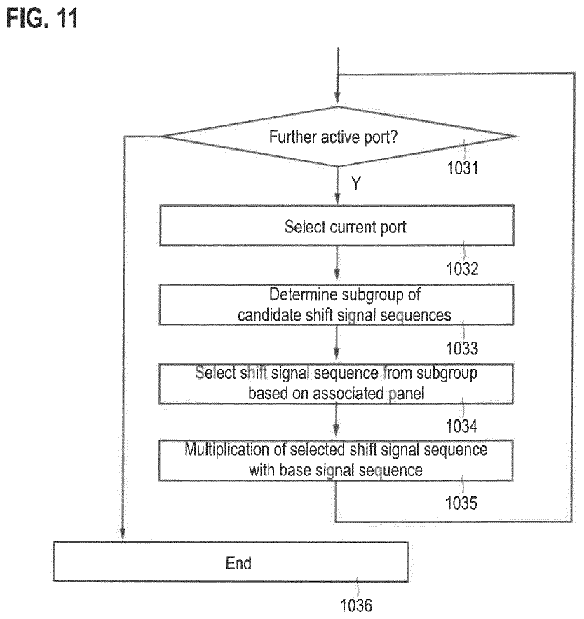

FIG. 10 is a signaling diagram of communication between the BS 101 and the UE 102.

At 4500, a DL control signal 152 is transmitted by the BS 101 and received by the UE 102. For example, a Radio Resource Control (RRC) DL control information message including a respective indicator or information field may be communication at 4500. The DL control signal is indicative of whether selection of the shift signal sequence depending on both the antenna port 5031-5033, as well as the antenna panel 5023-5024 is activated. To give an example, the DL control signal may take two or more values: a first value may indicate that the shift signal sequence is selected from the plurality of candidate shift signal sequences only depending on the antenna port (but not depending on the antenna panel); a second value may indicate that the shift signal sequence is selected from the plurality of candidate shift signal sequences depending on, both, the antenna port, as well as the antenna panel. A (optional) third value may indicate that the shift signal sequence is selected from the plurality of candidate shift signal sequences only depending on the antenna panel (but not depending on the antenna port).

In the example of FIG. 10, the DL control signal 152 indicates that the selection of the shift signal sequence from the plurality of candidate shift signal sequences is to depend on both the antenna port as well the antenna panel.

While in the example of FIG. 10 a DL control signal 152 is transmitted (and, hence, the decision logic for the configuration of the SRS sequence is located at the BS 101) in other examples the corresponding decision logic may reside at the UE 102 and an UL control signal may be transmitted by the UE 102 and received by the BS 101.

Further, while in the scenario of FIG. 10 an explicit indicator is used to indicate whether selection of the shift signal sequence depending on both the antenna port 5031-5033, as well as the antenna panel 5023-5024 is activated, in other examples a more implicit indication may be implemented. For example, a parameter that defines how the SRS sequence is used (e.g. for beam management, UL channel sounding information acquisition for codebook, UL channel sounding information acquisition for non-codebook, DL channel sounding information acquisition etc.) may be re-used: here, where the parameter defines beam management, the selection of the shift signal sequence from the plurality of candidate shift signal sequences depending on both the antenna port as well the antenna panel can be activated.

At 4501, the UE 102 transmits a configuration control message 151 to the BS 101. For instance, the configuration control message 151 may be indicative of a least one of a count of antenna ports, a count of antenna panels, a count of activated antenna ports, a count of activated antenna panels, a count of deactivated antenna ports, a count of deactivated antenna panels, and wiring of the antenna ports and antenna panels, etc.

It is possible that based on information included in the configuration control message 151, both, the BS 101, as well as the UE 102 determine the appropriate mapping 701, 702. Thereby, the mapping 701, 702 can be synchronized between the UE 102 and the BS 101.

While in the example of FIG. 10 implicit information allowing to determine the mapping at, both, the BS 101, as well as the UE 102 is transmitted as part of the configuration control message 151, in other examples, it would also be possible that more explicit information regarding the applicable mapping 701, 702 is communicated between the UE 102 and the BS 101. For example, the particular mapping may be selected from a codebook.

Then, at 4502-4504, multiple SRS sequences 150 are transmitted by the UE 102 and received by the BS 101. The SRS sequences 150 are transmitted in shared time-frequency resource elements 161 using CDD (not illustrated in FIG. 10); this is achieved by employing different shift signal sequences. The difference shift signal sequences are selected from a plurality of candidate shift signal sequences depending on the particular antenna port and antenna panel of the SRS sequence. For this, the mapping 701, 702 determined based on the information content of the configuration control message 151 is employed. Also, the BS 101 employs the mapping 701, 702 to determine the particular antenna port—antenna panel pair used for transmitting the respective SRS sequences.

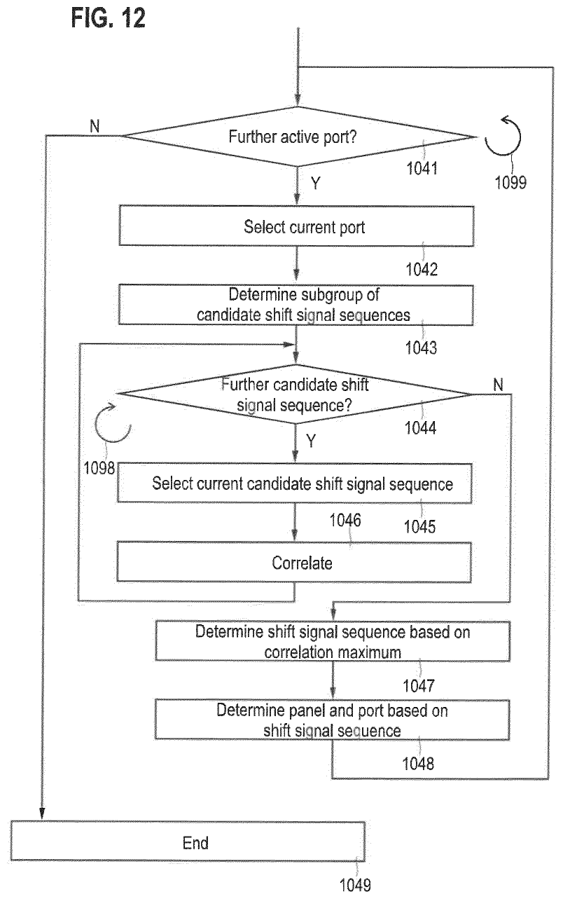

Details with respect to how the mapping 701, 702 is employed are explained below in connection with FIG. 11 and FIG. 12.

FIG. 11 is a flowchart of a method according to various examples. The method of FIG. 11 could be executed by a UE, e.g., the UE 102 according to FIG. 1 or FIG. 2. The method of FIG. 11 describes aspects with respect to generating multiple SRS sequences 150. For example, the method of FIG. 11 could be executed as part of block 1001 of the method according to FIG. 5.

Initially, at block 1031, it is checked whether one or more activated antenna ports remain for which a corresponding SRS sequence 150 has to be generated. If yes, then, at block 1032, a current antenna port of the remaining active antenna ports is selected.

Next, at block 1033, a subset of candidate shift signal sequences is determined, from all available candidate shift signal sequences; the available candidate shift signal sequences are defined by the respective mapping 701, 702 (which, in turn, optionally may be determined by the length of the base signal sequence and/or may be synchronized with the BS 101).

The subset is associated with the respective antenna port. The subset has a magnitude that corresponds to the number of available antenna panels for the particular antenna port (for illustration, referring to FIG. 7 and FIG. 8, here the subset of candidate shift sequences associated with the port “X” would be n={1,2,3}). This may take into account the wiring 5035 (cf. FIG. 3); however, in a simple scenario, it can be assumed that all antenna panels can be used for transmission by the respective antenna port.

Next, at block 1034, the particular shift signal sequence to be used for generating the SRS sequence 150 is selected from the subset, based on the respective antenna panel (for example, referring to FIG. 7 and FIG. 8, if the panel “B” is used, then n=2 is selected from the subset n={1,2,3}).

Then, at block 1035, the SRS sequence is finally generated by the element-wise multiplication of the selected shift signal sequence with the base signal sequence, cf. Eq. (2).

Then, block 1031 is re-executed in a further iteration. If no more active ports remain for which a respective SRS sequence 150 has to be generated, the method ends at block 1036.

The operation of the method of FIG. 11 can be further illustrated for a scenario in which all P antenna panels are coupled to all L antenna ports, i.e., there is a L-to-P wiring. Here, L*P shift signal sequences are required to accommodate for all possible antenna port—antenna panel pairs, see Eq. (8). Hence, a number of L*P candidate shift signal sequences is required, expressed by the vectors fₙ, see Eqs. (3) and (6): φₙ=(n−1) π/(L*P). Again, the index n corresponds to a certain antenna port k—antenna panel p pair. For example, n may be given by n=L*(p−1)+k−1. In this scenario, the L*P candidate shift signal sequences can be assigned to L subsets, each subset comprising P vectors. Then, for an SRS sequence transmitted via antenna port k and via panel p, pick the pth vector from the kth subset.

FIG. 12 is a flowchart of a method according to various examples. The method of FIG. 12 could be executed by BS, e.g., the BS 101 according to FIG. 1 or FIG. 2. The method of FIG. 12 is inter-related with the method of FIG. 11: The method of FIG. 12 describes aspects with respect to determining the antenna port and antenna panel from which a SRS sequence 150 that is received by the BS originates from. For example, the method of FIG. 12 could be executed as part of blocks 1012 and 1013 of the method according to FIG. 6.

In FIG. 12, the BS 101 receives, in a sequence of time-frequency resources, a signal sequence that comprises multiple code-multiplexed SRS sequences. Each one of the SRS sequences corresponds to a particular antenna port of a plurality of antenna ports.

Initially, at block 1041 it is checked whether a further active antenna port of the UE remains to be checked. Block 1041 is associated with an outer loop 1099 of multiple iterations; here, each iteration of the outer loop 1099 corresponds to a particular one of the code-multiplexed SRS sequences.

If the check in block 1041 yields yes, then, at block 1042, a current antenna port is selected.

At block 1043, a subset of all candidate shift signal sequences is determined, based on the current antenna port as selected at block 1042. Here, the previously determined mapping 701, 702 can be taken into account. All candidate shift signal sequences that are associated with the current antenna port can be included in the subset.

Next, at block 1044, it is checked whether a further candidate shift signal sequence remains to be checked for the subset of candidate shift signal sequences determined at block 1043. Block 1044 is associated with an inner loop 1098 of multiple iterations.

If yes, then at block 1045, a current candidate shift signal sequences selected from the subset and, at block 1046, a correlation between the current candidate shift signal sequence and the received signal sequence is performed. A magnitude of the correlation can be stored. Then, block 1044 is re-executed; i.e., a next iteration of the inner loop 1098.

If, at block 1044, it is determined that there is no further candidate shift signal sequence to be checked for the current port, then the method commences with block 1047. Here, the shift signal sequence used at the UE to generate the SRS sequence associated with the current iteration of the outer loop 1099 is determined based on the highest magnitude of all correlations of the iterations of the inner loop 1098.

Then, based on the mapping 701, 702, it is possible to conclude back on the antenna panel and antenna port used by the UE to transmit the current SRS sequence.

Next, block 1041 is re-executed, i.e., it is checked whether a further antenna port needs to be considered, i.e., a further SRS sequence needs to be identified. If yes, at block 1042 the next antenna port is selected; a further iteration of the outer loop 1099 commences. Otherwise, the method ends at block 1049.

The operation of the method of FIG. 12 can be further illustrated for a scenario in which all P antenna panels are coupled to all L antenna ports. For each antenna port k=1 . . . L do the following: (i) Correlate the received signal sequence with the P candidate shift signal sequences in subset k, see blocks 1045, 1046; (ii) determine the maximum magnitude of said correlation values, see block 1047; and (iii) if the maximum value corresponds to the pth candidate shift signal sequence in said subset, decide that antenna port k is transmitting its SRS sequence at antenna panel p.

Summarizing, techniques have been described that facilitate indicating which antenna panel and antenna port a SRS sequence has been transmitted from. In reference implementations, the received signal sequence is correlated to L candidate shift signal sequences, each one corresponding to one antenna port. According to examples described herein, the received signal sequence is correlated with up to L*P candidate shift signal sequences, to accommodate information on the antenna port used for transmission; thus, it is possible to accommodate additional information on the antenna panel.

A simple example: a 3-bit word can carry 8 different states. In reference implementations, only the two first bits (4 states) are used to indicate the antenna port being used; according to examples, the third bit is used to indicate what antenna panel is used.

Various techniques are based on the finding that for a flat channel fading, i.e., a channel where all the M symbols of the SRS sequence experience the very same channel, the error performance in distinguishing between the various code-multiplexed SRS sequences at the receiver is good, as long as the used shift signal sequences are orthogonal to each other. For selective channels, however, the error performance may degrade, because the assumption of pairwise orthogonality of the shift signal sequences according to the DFT vectors fₙ does not hold true. By using more candidate shift signal sequences to accommodate for the information on the antenna panel, the likelihood of having a pair of shift signal sequences that is not mutually orthogonal increases.

Various techniques are further based on the finding that in practical communication systems, such non-orthogonal shift signal sequences may not impose significant restrictions. First, it has been found that mm-wave channels are directive, so that the frequency selectivity is not nearly as severe as for sub-6 GHz channels. Second, typically, the number of panels is not a large number, most likely 2 or 3. Thus, L*P remains small, see Eq. (8). Third, in SRS sequence is partly transmitted in the frequency domain, and partly in the time-domain. In the time-domain the selectivity of the channel is next to none.

For scenarios where L*P≈M or even L*P>M, it is possible to expand M by selecting a longer base sequence. This adds some signaling overhead, but also an alternative reference implementation (e.g., an explicit list of antenna port—panel associations via a control channel) would impose signaling overhead. Thus, the expansion of M to cover both the number of antenna ports and number of panels can be beneficial. Thus, the length of the base sequence may be generally determined based on the count of antenna ports and antenna panels.

Further, in many cases the channel does not allow usage of all hardware-available L antenna ports. If less ports are being activated (and some antenna ports are being deactivated), then, candidate shift signal sequences may not be provisioned for deactivated antenna ports. Instead, the available candidate shift signal sequences may be mapped only to activated antenna ports and activated antenna panels (cf. FIG. 8).

Summarizing, the following examples have been described:

EXAMPLE 1. A method of operating a wireless communication device (102), comprising:

generating (1001) a reference signal sequence (150) based on a base signal sequence and a shift signal sequence selected from a plurality of candidate shift signal sequences, and

transmitting (1002) the reference signal sequence (150) via an antenna port (5031-5033) of a plurality of antenna ports (5031-5033) of the wireless communication device (102) and via an antenna panel (5023, 5024) of a plurality of antenna panels (5023, 5024) of the wireless communication device (102),

wherein the shift signal sequence is selected from the plurality of candidate shift signal sequences depending on the antenna port (5031-5033) and the antenna panel (5023, 5024) used for transmitting the reference signal sequence (150).

EXAMPLE 2. The method of EXAMPLE 1, further comprising:

selecting a subset of candidate shift signal sequences from the plurality of candidate shift signal sequences based on the antenna port (5031-5033), and

selecting the shift signal sequence from the subset of candidate shift signal sequences based on the antenna panel (5023, 5024).

EXAMPLE 3. The method of EXAMPLE 1 or 2, further comprising:

selecting a length of the base signal sequence depending on at least one of a count of the plurality of antenna ports (5031-5033) or a count of the plurality of antenna panels (5023, 5024), or a coupling between the plurality of antenna ports (5031-5033) and the plurality of antenna panels (5023, 5024).

EXAMPLE 4. The method of any one of the preceding EXAMPLEs,

wherein the shift signal sequence is selected from the plurality of candidate shift signal sequences based on a mapping (701, 702) between (i) the plurality of antenna ports (5031-5033) and the plurality of antenna panels (5023, 5024), and (ii) the plurality of candidate shift signal sequences.

EXAMPLE 5. The method of EXAMPLE 4,

wherein the mapping (701, 702) is predefined or synchronized between an access node (101) and the wireless communication device (102).

EXAMPLE 6. The method of EXAMPLE 4 or 5, further comprising:

determining the mapping (701, 702) based on one or more active antenna panels (5023, 5024) of the plurality of antenna panels (5023, 5024) or active antenna ports (5031-5033).

EXAMPLE 7. The method of any one of the preceding EXAMPLEs, further comprising:

communicating a control signal (152) indicative of whether selection of the shift signal sequence from the plurality candidate shift signal sequences depending on the antenna port (5031) and the antenna panel (5023, 5024) is activated.

EXAMPLE 8. A method of operating an access node (101) of a communications network, comprising:

receiving (1011) a signal sequence from a wireless communication device (102),

comparing (1012) the signal sequence with candidate shift signal sequences of a plurality of candidate shift signal sequences, each one of the candidate shift signal sequences being associated with an antenna panel (5023, 5024) of a plurality of antenna panels (5023, 5024) of the wireless communication device (102) and an antenna port (5031-5033) of a plurality of antenna ports (5031-5033) of the wireless communication device (102), and

determining (1013) the antenna panel (5023, 5024) and the antenna port (5031-5033) based on said comparing.

EXAMPLE 9. The method of EXAMPLE 8, wherein said comparing comprises, for each antenna port (5031-5033) of the plurality of antenna ports (5031-5033):

selecting a subset of candidate shift signal sequences from the plurality of candidate shift signal sequences based on the respective antenna port (5031-5033), and

comparing the signal sequence with the candidate shift signal sequences of the respective subset.

EXAMPLE 10. The method of EXAMPLE 8 or 9,

wherein the antenna panel (5023, 5024) and the antenna port (5031-5033) are determined further based on a mapping (701, 702) between (i) the plurality of antenna ports (5031-5033) and the plurality of antenna panels (5023, 5024), and (ii) the plurality of candidate shift signal sequences.

EXAMPLE 11. The method of EXAMPLE 10,

wherein the mapping (701, 702) is predefined or synchronized between the access node (101) and the wireless communication device (102).

EXAMPLE 12. The method of EXAMPLE 10 or 11, further comprising:

determining the mapping (701, 702) based on one or more active antenna panels (5023, 5024) of the plurality of antenna panels (5023, 5024) or active antenna ports (5031-5033).

EXAMPLE 13. A wireless communication device (102) comprising control circuitry (5021, 5022, 5025) configured to:

generate a reference signal sequence (150) based on a base signal sequence and a shift signal sequence selected from a plurality of candidate shift signal sequences,

transmit the reference signal sequence (150) via an antenna port (5031-5033) of a plurality of antenna ports (5031-5033) of the wireless communication device (102) and via an antenna panel (5023, 5024) of a plurality of antenna panels (5023, 5024) of the wireless communication device (102),

wherein the shift signal sequence is selected from the plurality of candidate shift signal sequences depending on the antenna port (5031-5033) and the antenna panel (5023, 5024) used for transmitting the reference signal sequence (150).

EXAMPLE 14. The wireless communication device (102) of EXAMPLE 12, wherein the control circuitry (5021, 5022, 5025) is configured to execute the method of any one of EXAMPLEs 1 to 7.

EXAMPLE 15. An access node (101) of a communications network, the access node (101) comprising control circuitry (5011, 5012, 5015) configured to:

receive a signal sequence from a wireless communication device (102),

compare the signal sequence with candidate shift signal sequences of a plurality of candidate shift signal sequences, each one of the candidate shift signal sequences being associated with an antenna panel (5023, 5024) of a plurality of antenna panels (5023, 5024) of the wireless communication device (102) and an antenna port (5031-5033) of a plurality of antenna ports (5031-5033) of the wireless communication device (102), and

determine the antenna panel (5023, 5024) and the antenna port (5031-5033) based on said comparing.

EXAMPLE 16. The access node (101) of EXAMPLE 14, wherein the control circuitry (5011, 5012, 5015) is configured to execute the method of any one of EXAMPLEs 8 to 12.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For example, while various examples have been described in connection with SRS sequences, similar techniques may also be employed for other kinds and types of reference signals—e.g., DL reference signals or sidelink reference signals.

1. A method of operating a wireless communication device, comprising:
generating a reference signal sequence based on a base signal sequence and a shift signal sequence selected from a plurality of candidate shift signal sequences, and
transmitting the reference signal sequence via an antenna port of a plurality of antenna ports of the wireless communication device and via an antenna panel of a plurality of antenna panels of the wireless communication devices),
wherein the shift signal sequence is selected from the plurality of candidate shift signal sequences depending on the antenna port and the antenna panel used for transmitting the reference signal sequence.

2. The method of claim 1, further comprising:
selecting a subset of candidate shift signal sequences from the plurality of candidate shift signal sequences based on the antenna port, and
selecting the shift signal sequence from the subset of candidate shift signal sequences based on the antenna panel.

3. The method of claim 1, further comprising:
selecting a length of the base signal sequence depending on at least one of a count of the plurality of antenna ports or a count of the plurality of antenna panels, or a coupling between the plurality of antenna ports and the plurality of antenna panels.

4. The method of claim 1,
wherein the shift signal sequence is selected from the plurality of candidate shift signal sequences based on a mapping between the plurality of antenna ports and the plurality of antenna panels, and the plurality of candidate shift signal sequences.

5. The method of claim 4,
wherein the mapping is predefined or synchronized between an access node and the wireless communication device.

6. The method of claim 4, further comprising:
determining the mapping based on one or more active antenna panels of the plurality of antenna panels or active antenna ports.

7. The method of claim 1, further comprising:
communicating a control signal indicative of whether selection of the shift signal sequence from the plurality candidate shift signal sequences depending on the antenna port and the antenna panel is activated.

8. A method of operating an access node of a communications network, comprising:
receiving a signal sequence from a wireless communication device,
comparing the signal sequence with candidate shift signal sequences of a plurality of candidate shift signal sequences, each one of the candidate shift signal sequences being associated with an antenna panel of a plurality of antenna panels of the wireless communication device and an antenna port of a plurality of antenna ports of the wireless communication device, and
determining the antenna panel and the antenna port based on said comparing.

9. The method of claim 8, wherein said comparing comprises, for each antenna port of the plurality of antenna ports;
selecting a subset of candidate shift signal sequences from the plurality of candidate shift signal sequences based on the respective antenna port, and
comparing the signal sequence with the candidate shift signal sequences of the respective subset.

10. The method of claim 8,
wherein the antenna panel and the antenna port are determined further based on a mapping between the plurality of antenna ports and the plurality of antenna panels, and the plurality of candidate shift signal sequences.

11. The method of claim 10,
wherein the mapping is predefined or synchronized between the access node and the wireless communication device.

12. The method of claim 10, further comprising:
determining the mapping based on one or more active antenna panels of the plurality of antenna panels or active antenna ports.

13. A wireless communication device comprising control circuitry configured to:
generate a reference signal sequence based on a base signal sequence and a shift signal sequence selected from a plurality of candidate shift signal sequences,
transmit the reference signal sequence via an antenna port of a plurality of antenna ports of the wireless communication device and via an antenna panel of a plurality of antenna panels of the wireless communication device,
wherein the shift signal sequence is selected from the plurality of candidate shift signal sequences depending on the antenna port and the antenna panel used for transmitting the reference signal sequence.

14. An access node of a communications network, the access node comprising control circuitry configured to:
receive a signal sequence from a wireless communication device,
compare the signal sequence with candidate shift signal sequences of a plurality of candidate shift signal sequences, each one of the candidate shift signal sequences being associated with an antenna panel of a plurality of antenna panels of the wireless communication device and an antenna port of a plurality of antenna ports of the wireless communication device, and
determine the antenna panel and the antenna port based on said comparing.
